(19) United States
(12) Patent Application Publication
(10) Pub. No.: US 2011/0247217 A1
(43) Pub. Date: Oct. 13, 2011

(54) SHAVING CARTRIDGE HAVING A FRONT PIVOTING HOOD WITH A BIASING MEMBER

(76) Inventors: Robert Harold Johnson, Melrose, MA (US); Alejandro Carlos Lee, Cambridge, MA (US)

(21) Appl. No.: 13/040,360

(22) Filed: Mar. 4, 2011

Related U.S. Application Data
(60) Provisional application No. 61/323,069, filed on Apr. 12, 2010.

(51) Int. Cl. B26B 21/14

(52) U.S. Cl. 30/50

(57) ABSTRACT

Shaving cartridges intended for connection to handles to form shaving razors wherein the cartridges comprise pivoting hood comprising a biasing member.

### CROSS REFERENCE TO RELATED APPLICATIONS

This application claims the benefit of U.S. Provisional Application No. 61/323,069 filed Apr. 12, 2010.

### FIELD OF THE INVENTION

This invention relates to a shaving cartridge that is suitable for mounting to a handle wherein the cartridge includes a pivoting hood with a biasing member.

### BACKGROUND OF THE INVENTION

Razors for wet shaving typically include a cartridge carried by a handle, the cartridge including an elongate blade with a rectilinear sharpened edge, or a plurality of such blades with parallel edges. The cartridge may be fixedly mounted on the handle with the intention that the entire razor be discarded when the blade edge or edges have become dulled. Alternatively, the cartridge can be detachably connected to the handle to enable replacement of a used cartridge with a fresh cartridge.

In the recent past, manufacturers have commercialized razors that exhibit front pivot. For instance, the Fusion® razor, which is commercially available from The Gillette Company, possesses a front pivot as described in U.S. Pat. No. 7197825 B2, issued to Vincent Walker et al. on Apr. 4, 2007. In this instance, however, the biasing of the front pivot is achieved by a spring-loaded plunger that is located at a proximate tip of a handle that is paired with the cartridge. Similarly, the Mach3 razor includes a similar handle. In both cases, the spring-loaded plunger of the handle is inserted into and through a hood on a cartridge and interacts with a rear surface of the cartridge to yield biasing of the cartridge during use.

Another known shaving device is the M5 Magnum razor, marketed by Persona.

Applicant has recognized in the aforementioned products as well as in other shaving razors there seems to be no presence of a cartridge that is biased independent of the handle. Without being limited by theory, it is believed that such a development would aid in improving the contact of the blades with the skin of a shaving consumer.

### SUMMARY OF THE INVENTION

The present invention features a shaving cartridge that includes a self-biased, front pivoting mechanism. The invention is directed to a shaving cartridge for connection to a handle, the shaving cartridge comprising:
a) a blade unit having an upper surface and a lower surface wherein said unit further comprises a plurality of blades;
b) a frame secured to and surrounding said blade unit, said frame comprising a periphery that further comprises a front edge portion, a rear edge portion, and perpendicularly disposed lateral right and left edge portions;
c) a pivoting hood joined to said frame at said lateral right and left edge portions by opposing arms, said hood forming a pivoting axis forward of said blade unit and within said frame, wherein said pivoting hood further comprises a biasing member having a cam following surface and that extends from said pivoting hood to act on a cam on the lower surface of said blade unit.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 is a rear perspective view of the cartridge to one embodiment of the invention.

FIG. 2 is a rear perspective view of another cartridge of the present invention which lacks the shaving aid portions.

FIG. 3 is a side view of the cartridge of FIG. 2.

FIG. 4 is a bottom view of another cartridge embodiment of the invention.

FIG. 5 is a bottom view of yet another cartridge embodiment of the invention.

### DETAILED DESCRIPTION OF THE INVENTION

The present invention is directed to a shaving cartridge having a front pivoting, self-biased hood. As used herein “front pivot” refers to position a pivot axis of a cartridge in front of plurality of blades contained within a blade unit. It should be understood that the front of the cartridge is at or adjacent to a front edge portion of the cartridge. As used herein, “majority” or “mostly” means greater than 50%, 60%, 70%, 80%, 90%, or even 100% is made of or includes an elastomeric material.

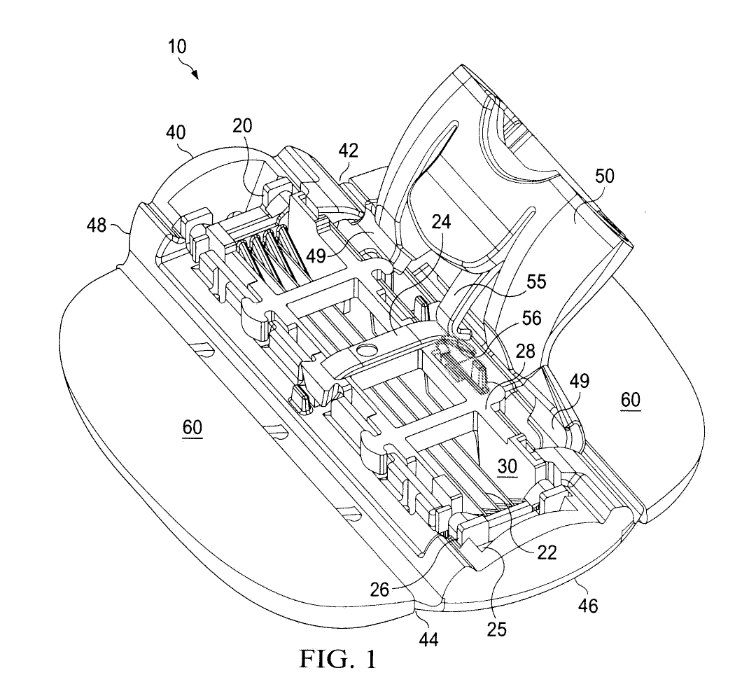

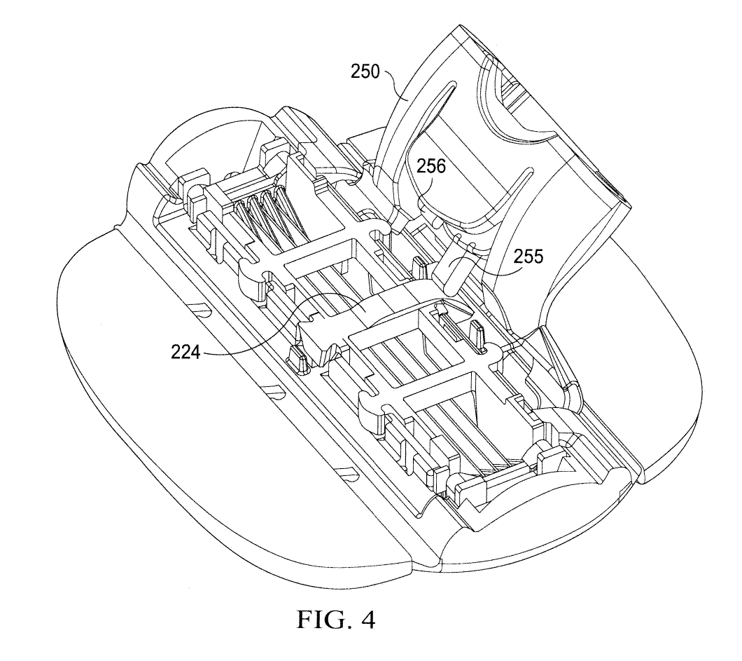

FIG. 1 shows a shaving cartridge 10 according to the present invention. The shaving cartridge comprises a blade unit 20 having an upper surface 25 and a lower surface 28. The blade unit 20 includes a plurality of blades 22. Such blades are disposed in a parallel arrangement in relation to one another and include sharp cutting edges suitable for shaving hair from skin when moved along skin in a direction opposing the cutting edges. The blades may be spring mounted or fixed within a housing 30 of the blade unit. A frame 40 surrounds the blade unit 20. In other words, the blade unit 20 is disposed within aperture 26 of the frame 40. The frame 40 has a periphery that includes a front edge portion 42, a rear edge portion 44, and opposing perpendicularly disposed lateral right and left edge portions 46, 48. A pivoting hood 50 is joined to the frame 40. This joinder occurs at or adjacent to the respect right and left edge portions 46, 48 via opposing arms 49. At the points of joinder of the hood with the frame 40, a pivoting axis forward (in front of) the blade unit 20 is created. The pivoting axis forms a front pivot that is biased against by a biasing member 55 that has a cam following surface 56 at its tip. This cam following surface 56 of the biasing member 55 extends out from the pivoting hood 50 and comes in contact with a cam 24 which is disposed on the lower surface 28 of the blade unit 20. In this instance, the biasing member 55 is a cantilever spring. It is possible, however, that the biasing member 55 may take the form of any other type of spring that is comparable, e.g., a spring loaded plunger (as shown in FIG. 4). At the points where the biasing member 55 contacts the lower surface, i.e., the cam 24, and at the opposing arms 49 of the pivoting hood 50, pivoting of the frame 40 is permitted in only one direction from an at-rest position. The front pivoting hood 50 provides for the biasing of the cartridge 10 to be motivated by a biasing member 55 that is part and parcel of the cartridge 10 versus cartridges known in the prior art which do not include a biasing member. In the previous razors that have been commercially available, a biasing member that interacts with the cartridge (typically on a lower surface) is found at a proximate end of a handle which is contacted with the cartridge.

Also, shown in FIG. 1 are one or more shaving aid portions 60. Each of these shaving aid portions 60 may be supported or mounted onto a wing (not shown). The shaving aid portion 60 is mounted on a wing via a method known to those skilled in the art, e.g., pour molding or extrusion molding. Without being limited by theory, it is Applicant's expectation that the front pivoting caused by the interaction of the hood 50 and the lower surface 28 of the blade unit 20 promotes a more even wearing away of the shaving aid portion during use as well as a more comfortable and natural feeling, i.e., not awkward, shaving experience.

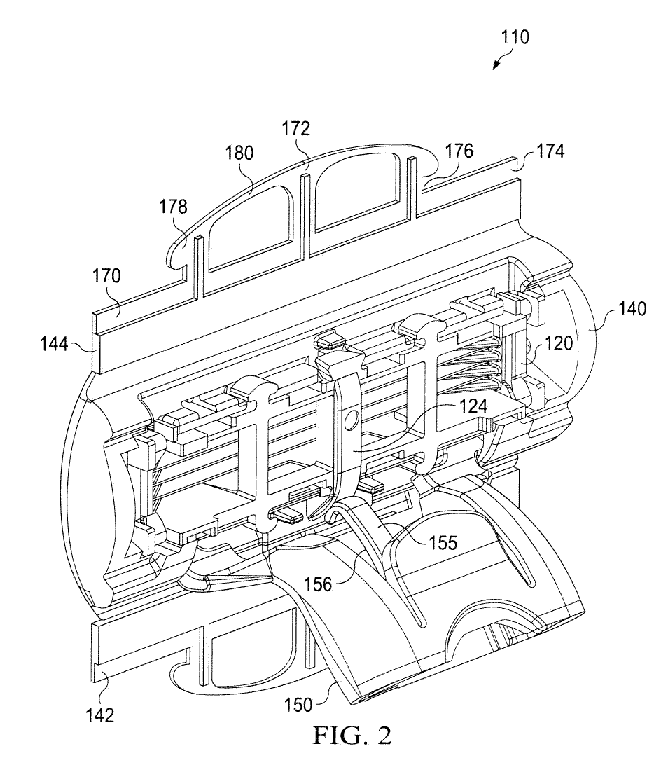

The shaving aid portions 60 of FIG. 1 spans a width of the wing such that the wing tabs (shown in FIG. 2) along a single wing are encompassed within a volume of the shaving aid portion. The shaving aid portion 60 resiliently deflects upon contact with the skin, from a normal, undeflected (concave) position to various flexed positions. This deflection allows the razor to be easily used in hard to reach or confined areas, such as the armpit (axilla) or behind the knee. Deflection of the shaving aid portion 60 also prevents premature wear of the shaving aid portion 60 and discomfort to the user in cases where the user applies excessive pressure during shaving. Any desired formulation may be used to form the shaving aid portions 60. In certain embodiments, the shaving aid portions 60 have sufficient wear resistance so that the shaving aid portions last for the intended life of the cartridge. If desired, the frame may be removable and replaceable by the consumer, in which case the shaving aid portions may be exhausted before it is necessary to replace the cartridge.

In some instances, the shaving aid portions 60 may include soap, e.g., poured or extruded soap. Such soap-based compositions may be modified to increase their hardness, wear resistance, lubricity and/or skin moisturizing and conditioning properties.

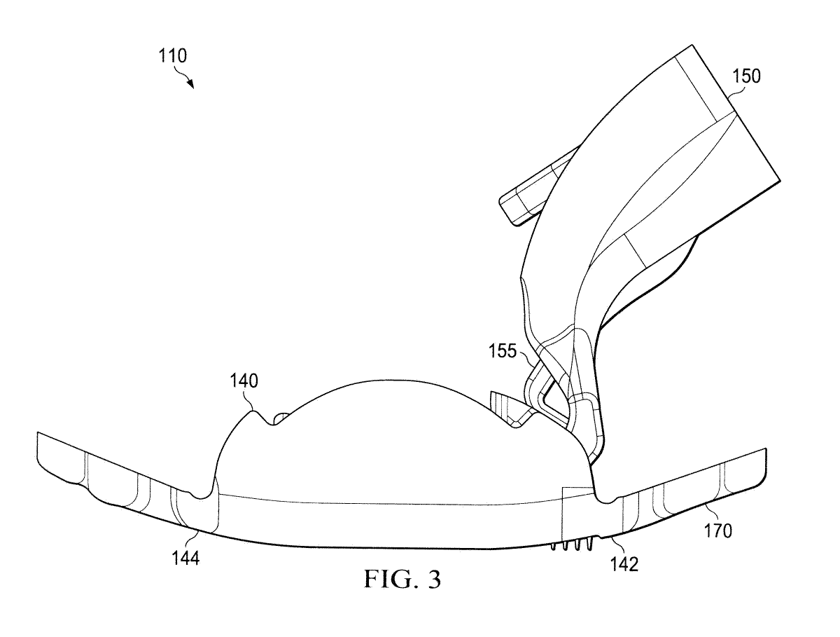

FIGS. 2 and 3 also show an alternate cartridge 110 of the present invention. This cartridge 110 is shown without a shaving aid portion in order that the wing 170 may be seen. The wing 170 is disposed at the front edge portion 142 and at the rear edge portion 144 of the frame 140. (Again, the frame 140 is surrounding the blade unit 120.) The wing 170 comprises a plurality of wing tabs 172 that extend from a base 174 of the wing 170. The wing 170 may be joined to the frame 140 via mechanical attachment, e.g., snapfitting an underside of the wing into recesses of the frame. Alternatively, the wing may be glued or bonded to the frame. In a particular embodiment, the wing which comprises a majority of elastomeric material may be joined via extruding the elastomeric material into a mold that contains a frame, which might be formed of rigid or semi-rigid plastic. Each wing tab 172 has a proximate end 176 and a distal end 178. In this embodiment, there is shown a retention member 180 that joins one or more of the wing tabs 172 to one another to form a unitary wing. The retention member 180 may span the distance between only two adjacent wing tabs or may span the distances between more than two wing tabs. Moreover, the retention member 180 may be present at the distal ends of the wing tabs (as shown in FIG. 2) or may be disposed between the distal and proximate ends of the respective wing tabs (not shown). In an alternate embodiment, the wing tabs 172 may be independently movable at their respective distal ends 178. The wing comprises mostly elastomeric material and this elastomeric material may have a hardness of less than about 50 Shore A, e.g., less than about 40 Shore A. The elastomeric material may be, for example, a block copolymer such as those available under the tradename KRATON®. In certain instances, the elastomeric material has sufficient chemical resistance so that it will not degrade during prolonged contact with the ingredients of the shaving aid portion.

Without being limited by theory, Applicant believes that the elastomeric nature of the wing and the respective wing tabs facilitate the conformation of the various areas of the shaving aid (e.g., left side, right side, center portion) to shape to the skin of a shaving consumer independently as a function of the amount of shaving aid that is worn away during use. For instance, in the event the right side of the shaving aid is worn away more readily than the left side, the elastomeric wing tab(s) on a right side of the wing will be able to press toward the skin to deliver the remaining shaving aid on the right side as long as such shaving aid exists. Likewise, it is anticipated that the various areas of the shaving aid will be able to bias toward the skin independently as required by the shaving consumer's use to deliver shaving aid from the shaving aid portion.

FIG. 4 merely shows the same cartridge as shown in FIG. 1 with the exception of the biasing member 255 which is different. Here, the biasing member 255 is a spring-loaded plunger. It should be noted that in this instance the biasing member 255 is not cooperating with a handle (to which it is paired) to provide any spring loaded biasing. Here, a spring-loaded plunger 256 contained on a handle is inserted through the hood 250 and peeks through the hood. Thus, there are two spring loaded plungers in this embodiment but only one is functional to provide biasing on the cartridge. This configuration allows a user to use a razor handle from one or more commercially available razors with this cartridge embodiment.

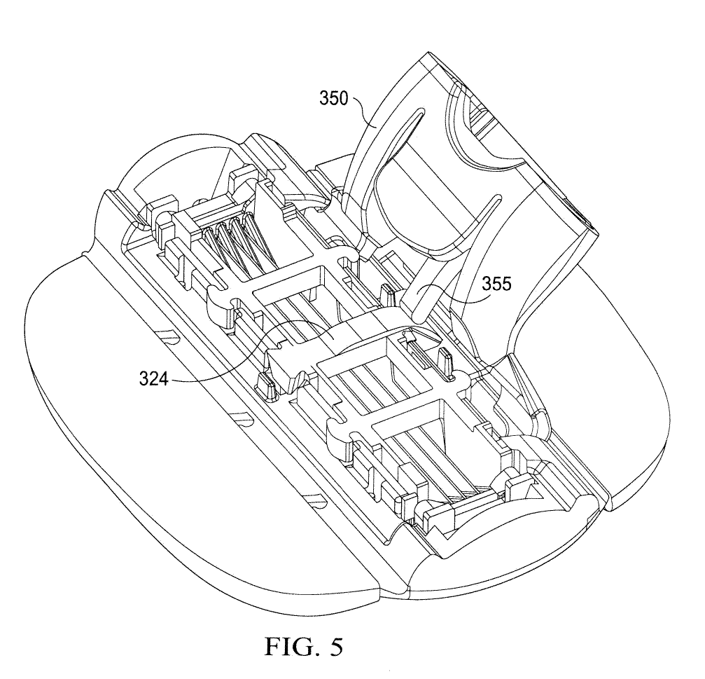

FIG. 5 shows a similar cartridge as shown in FIG. 1 with a different biasing member 355. In this case, the biasing member is another embodiment of a spring-loaded plunger. It is envisioned in this instance that a spring-loaded plunger containing handle (as seen in the commercially available Fusion® razor or the Mach3® razor, both which are manufactured by The Gillette Company) may be inserted into the hood 350 to cooperate with the biasing member 355 to provide a front pivoting action to the cartridge during use.

With regard to the cam 24, 224, 324 shown in each of FIGS. 1, 2, 4, and 5, it may have a shape selected from the group consisting of an arc, a slope, and a combination thereof.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving cartridge for connection to a handle, said shaving cartridge comprising:
a) a blade unit having an upper surface and a lower surface wherein said unit further comprises a plurality of blades;
b) a frame secured to and surrounding said blade unit, said frame comprising a periphery that further comprises a front edge portion, a rear edge portion, and perpendicularly disposed lateral right and left edge portions;
c) a pivoting hood joined to said frame at said lateral right and left edge portions by opposing arms that create a pivoting axis forward of said blade unit and within said frame, wherein said pivoting hood further comprises a biasing member having a cam following surface and that extends from said pivoting hood to act on a cam on the lower surface of said blade unit, wherein said biasing member comprises a spring-biased plunger.

2. The shaving cartridge of claim 1 wherein said cam has a shape selected from the group consisting of an arc, a slope, and a combination thereof.

3. The shaving cartridge of claim 1 wherein said biasing member comprises a cantilever spring.

4. The shaving cartridge of claim 1 wherein said pivoting hood receives a razor handle that comprises an additional biasing member.

5. The shaving cartridge of claim 1 wherein said biasing member pushes said blade unit to said upper surface of said frame.

6. The shaving cartridge of claim 1 wherein contact between said lower surface of said frame and of said arms of said pivoting hood permit pivoting of said frame in only one direction from an at-rest position.

7. The shaving cartridge of claim 1 wherein said frame comprises a wing disposed on at least one or more of said front and rear edge portions wherein a shaving aid portion is mounted on said wing.

8. The shaving cartridge of claim 7 wherein said wing comprises a plurality of wing tabs each having proximate and distal ends.

9. The shaving cartridge of claim 8 wherein one or more of the wing tabs are independently movable at their respective distal ends.

10. The shaving cartridge of claim 9 wherein the distal ends of one or more of said wing tabs are joined to one another via a retention member.

11. The shaving cartridge of claim 7 wherein said wing permits conformation of the shaving aid portion to a user's skin surface.

12. The shaving cartridge of claim 7 wherein said cartridge comprises an additional wing on an opposing edge of said unit from said first wing.
